(19) United States
(12) Patent Application Publication
(10) Pub. No.: US 2013/0198388 A1
(43) Pub. Date: Aug. 1, 2013

(54) DISTRIBUTED INFORMATION

(71) Applicant: Lokahi Solution, LLC, Waialua, HI (US)

(72) Inventor: Jeffrey M. Dahn, Waialua, HI (US)

(73) Assignee: LOKAHI SOLUTIONS, LLC, Waialua, HI (US)

(21) Appl. No.: 13/749,678

(22) Filed: Jan. 25, 2013

Related U.S. Application Data
(60) Provisional application No. 61/591,259, filed on Jan. 26, 2012.

(51) Int. Cl. H04L 29/08

(52) U.S. Cl. 709/226

(57) ABSTRACT

A system for distributing information includes a plurality of geographically distributed service nodes. Workload can be transferred between the nodes to improve various aspects of information management.

### RELATED APPLICATIONS

This Application claims priority to U.S. Provisional Patent Application No. 61/591,259, filed Jan. 26, 2012, and entitled “SYSTEM AND METHOD OF DISTRIBUTED INFORMATION” by Jeffrey M. Dahn et. al, which is incorporated herein by reference.

### BACKGROUND

Information processing systems take many forms. One of these forms is a utility model of information management called “Cloud Computing” or the networked use of a shared pool of configurable computing resources. Cloud computing is often characterized as having layers. From bottom to top, these layers are commonly referred to as the infrastructure layer, platform layer, and application layer.

Private cloud implementations place computing resources within a single organization's privately controlled data center. A variant of private cloud called “community clouds” may group the infrastructure of several organizations into a single private cloud accessible only by members of those organizations. Private clouds can be very expensive to construct and maintain and are often operated at only a fraction of their capacity.

Public clouds can reduce cost by sharing resources across multiple organizations, but such clouds have issues with security, reliability, latency, disaster recovery, and mobility. Public cloud infrastructure can be accessed through the public internet exposing the computing resources to denial of service, hacking, and other security threats. The centralization of resources can limit reliability because temporary loss of electric power or network connectivity can cause the cloud to fail. Further, centralized data centers are less resilient to floods, earthquakes, hurricanes, and other natural disasters. Additionally, performance degrades as the distance between the consumer and data center increases.

Existing solutions fail to solve these problems, for example, disaster recovery is often implemented at the application layer by adding redundancy to the system. Some providers operate two or more complete data centers in different regions. Such a solution is costly and impractical because the redundancy can multiply the cost and work required to maintain such systems. Similarly, attempts to modify the platform layer to address these issues have impacted application compatibility by deviating from standards relied upon by application developers.

Accordingly, it would be advantageous to devise a way to overcome these problems and inefficiencies of security, reliability, latency, disaster recovery, and mobility associated with the state of the art by providing improvements to the infrastructure layer.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

According to the teachings herein, the drawbacks of the prior art are resolved by communicatively coupling a plurality of service nodes and distributing them geographically. The service nodes can be located in close proximity to consumers to reduce the number of communication links between a particular customer and a service node. Such nodes can be monitored and workload can be transferred between the nodes. Geographic distance information can be used to transfer workload to customers in close proximity to nodes to reduce latency. Similarly, network distance can be used to reduce latency to customers. Such nodes can identify intrusions and service quality issues and transfer workload to unaffected nodes. Nodes can act as primary or secondary nodes as well as master nodes that oversee work performed by other nodes.

Advantageously, the system reduces latency to end users, shows improved reliability at the infrastructure level, and offers improved security, disaster recovery, and mobility as well as other relevant aspects of information management.

### BRIEF DESCRIPTION OF THE DRAWINGS

FIG. 1 depicts an example of a system for distributing information.

FIG. 2 depicts an example of a system for distributing information.

FIG. 3 depicts an example of a system for distributing information.

FIG. 4 depicts an example of an information service node.

FIG. 5 depicts a flowchart of an example of a method of distributing information.

FIG. 6 depicts a flowchart of an example of a method of distributing information.

FIG. 7 depicts a flowchart of an example of a method of distributing information.

FIG. 8 depicts a flowchart of an example of a method of responding to a request to specify a primary node.

FIG. 9 depicts a flowchart of an example of a method of distributing information.

FIG. 10 depicts a flowchart of an example of a method of distributing information.

FIG. 11 depicts a flowchart of an example of a method for moving a service.

FIG. 12 depicts an example of a system for distributing information.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

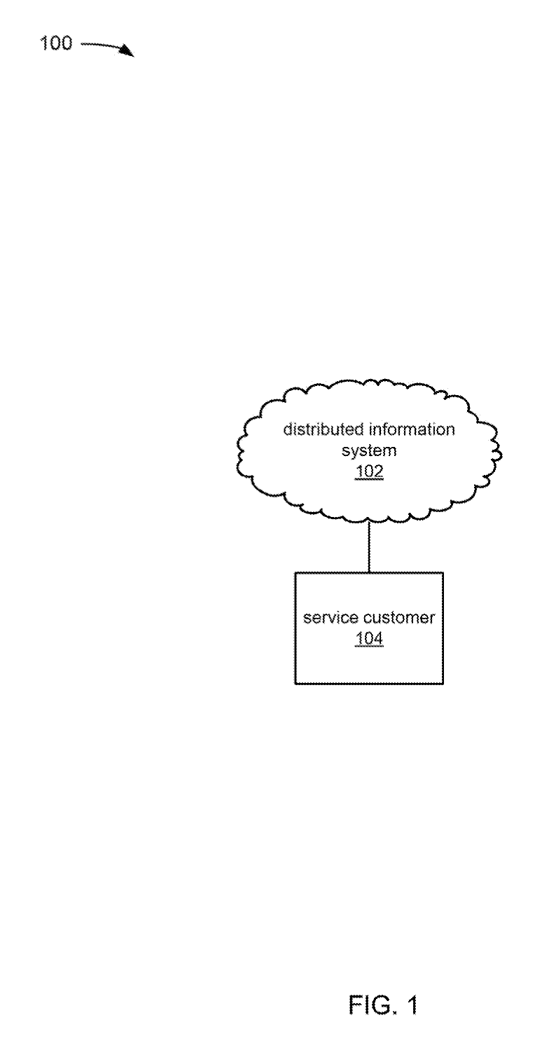

FIG. 1 depicts an example of a system 100 for distributing information. FIG. 1 includes distributed information system 102 and service customer 104. In the example of FIG. 1, the distributed information system 104 can be one or more computing systems coupled together to provide computing services and resources. Distributed information system 102 can include security infrastructure, computational resources, storage, and other known and convenient technologies.

In the example of FIG. 1, the service customer 104 can be a computing system requiring computing resources, whether processing, storage or otherwise. The service customer 104 has network access, whether public or private, sufficient to transmit data via a network to and to receive data back via the network.

In the example of FIG. 1, the distributed information system 102 can be communicatively coupled to the service customer via a network; the network can be practically any type of communications network, such as, by way of example but not limitation, the Internet or an infrastructure network. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). Further, network 104 can be a redundant network, or network having more than one communication path between service customer 104 and distributed information system 102.

In the example of FIG. 1, service customer 104 requests resources from distributed information system 102. This request is transmitted a certain amount of time, or latency, between service customer 104 and distributed information system 102. In the example of FIG. 1, distributed information system 102 can be located in close geographic proximity to service customer 104 or otherwise coupled to network 104 to minimize latency between service customer 104 and distributed information system 102. Latency can vary dependent upon numerous factors including, but not limited to, geographic distance between service customer 104 and distributed information system 102, the specific network topology provided by network 104, and the number of “hops,” or retransmissions, required to transmit data from service customer 104 to distributed information system 102.

Service customer 104 may also request or implicitly require that various processing tasks be performed by distributed information system 102. Such processing or “workload” can include the services provided, storage of data, execution of programs and other known or convenient tasks performed for service customer 104. Such workload can be performed by one or more computing systems included in distributed information system 102. Where the computing systems included in distributed information system 102 are not located in close geographic proximity to service customer 104, workload required by service customer 104 can be transferred to computing systems in close geographic proximity to service customer 104.

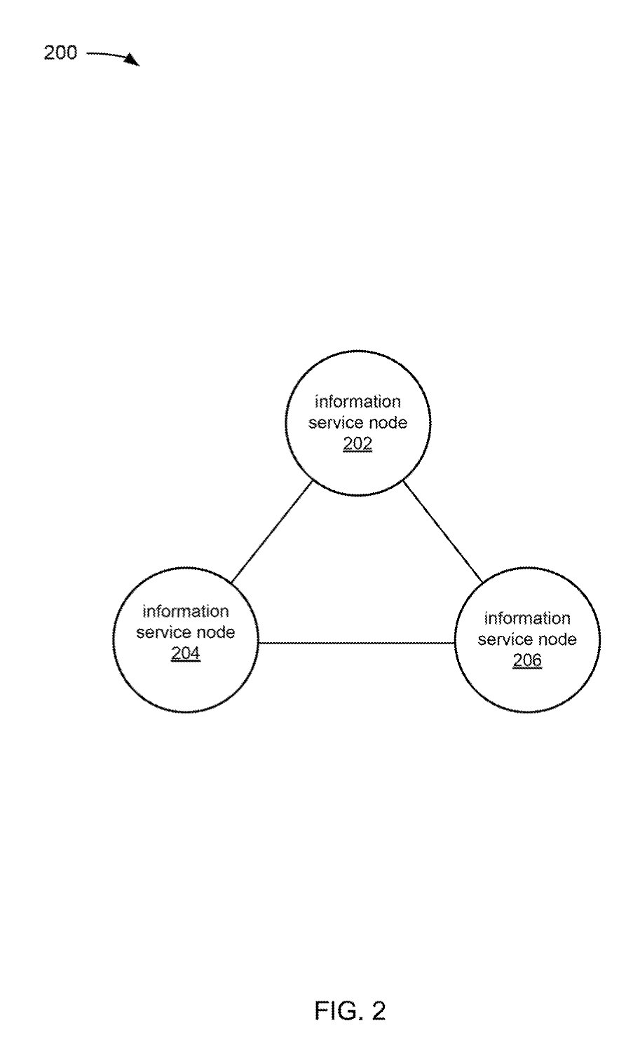

FIG. 2 depicts an example of a system 200 for distributing information. FIG. 2 includes information service node 202, information service node 204, and information service node 206. Each of information service node 202, information service node 204 and information service node 206 are fully connected. As used herein, “fully connected” means that each information service node has a direct communication path to each other information service node, whether via the internet, a direct communications link, or another known or convenient manner of transporting information.

One or more nodes of information service node 202, information service node 204, and information service node 206 can be a “master” node, or information service node operable to provide instruction to other information service nodes, “slave” nodes. Master nodes and slave nodes are operable to perform work on behalf of service customers, however, master nodes can make decisions as to which nodes perform such work and can provide instructions to move workload between nodes. Such “transfer” of workload can improve the service quality performed for service customers, respond to security threats and otherwise manage the distributed information system.

Additionally, an information service node can be assigned a workload. Such an information service node is then announced as the “primary” node for that workload. In the event that the primary node is unavailable, overloaded or otherwise incapable, a master node can reassign or transfer a workload to another node which becomes the primary node for that workload. Similarly, one or more other nodes can be assigned as “secondary” nodes that can handle overloads, share workloads or otherwise service customers in addition to the primary node.

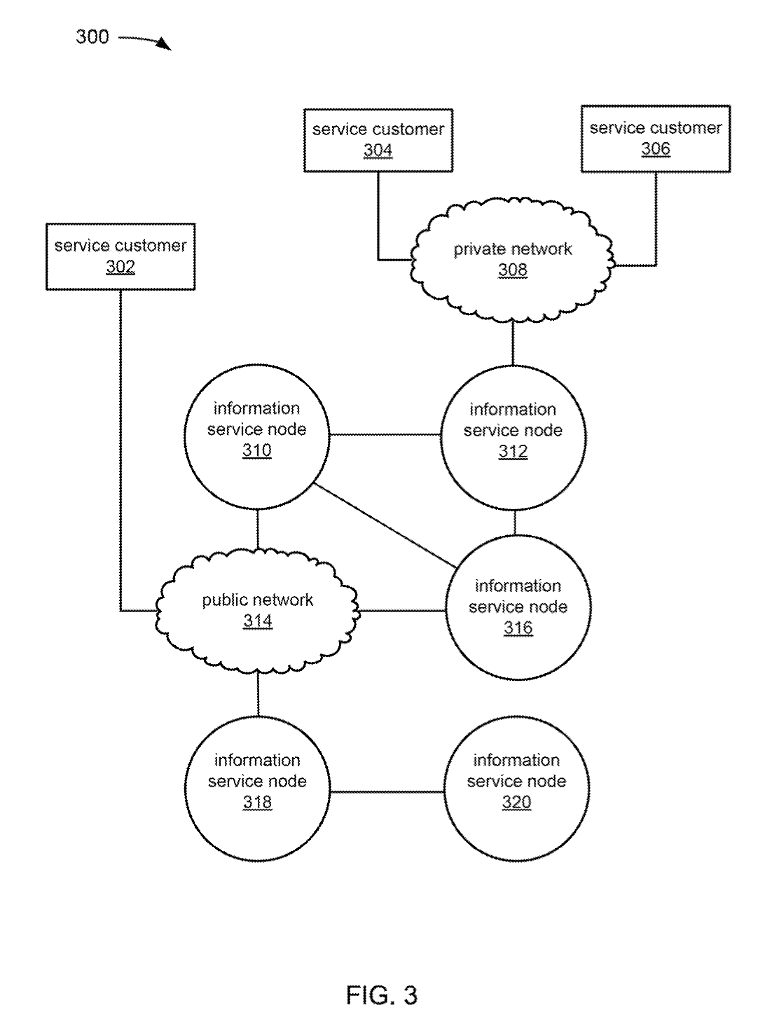

FIG. 3 depicts an example of a system 300 for distributing information. FIG. 3 includes service customer 302, service customer 304, service customer 306, private network 308, information service node 310, information service node 312, public network 314, information service node 316, information service node 318, and information service node 320.

In the example of FIG. 3, the plurality of service customers are coupled to the plurality of information service nodes via private network 308 and via public network 314. In the example of FIG. 3, private network 308 can include one or more communication links that are inaccessible to the general public. The private network 308 would typically exclude the Internet as a whole, and rather would allow only traffic authorized by the private network 308. Such a network could be a point to point network as simple as an individual wire, including an individual fiber connection, or as complex as a dedicated private frame-relay network including many network devices and associated cabling.

In the example of FIG. 3, public network 314 can be practically any type of communications network, such as, by way of example but not limitation, the Internet or an infrastructure network, as discussed above in reference to FIG. 1.

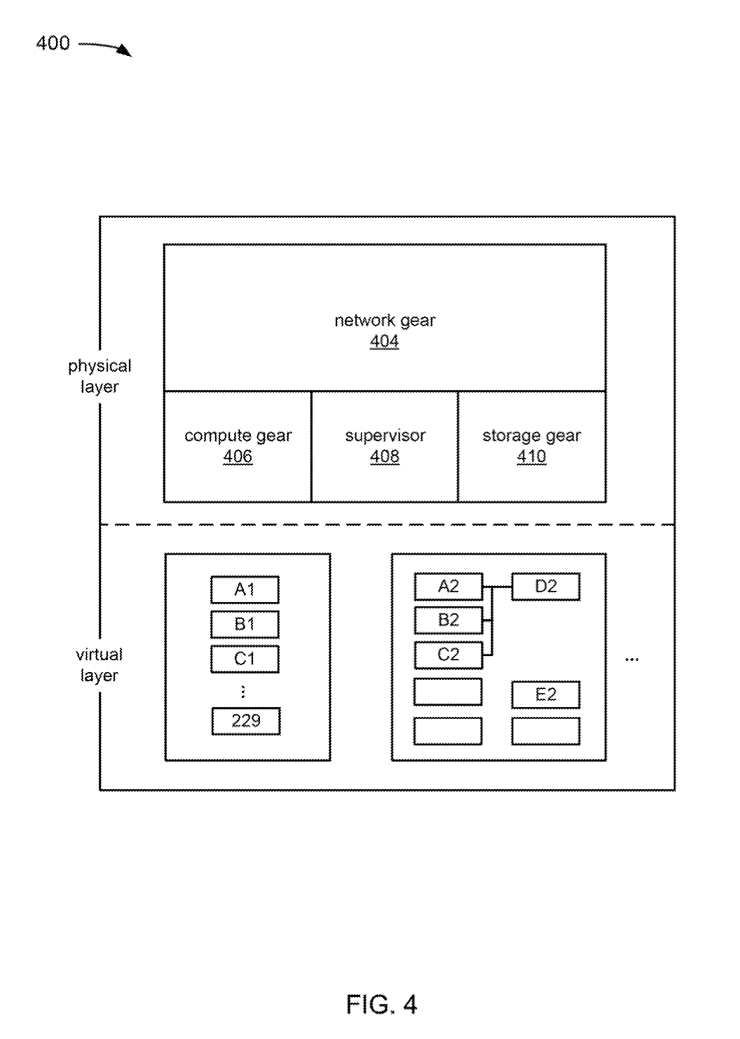

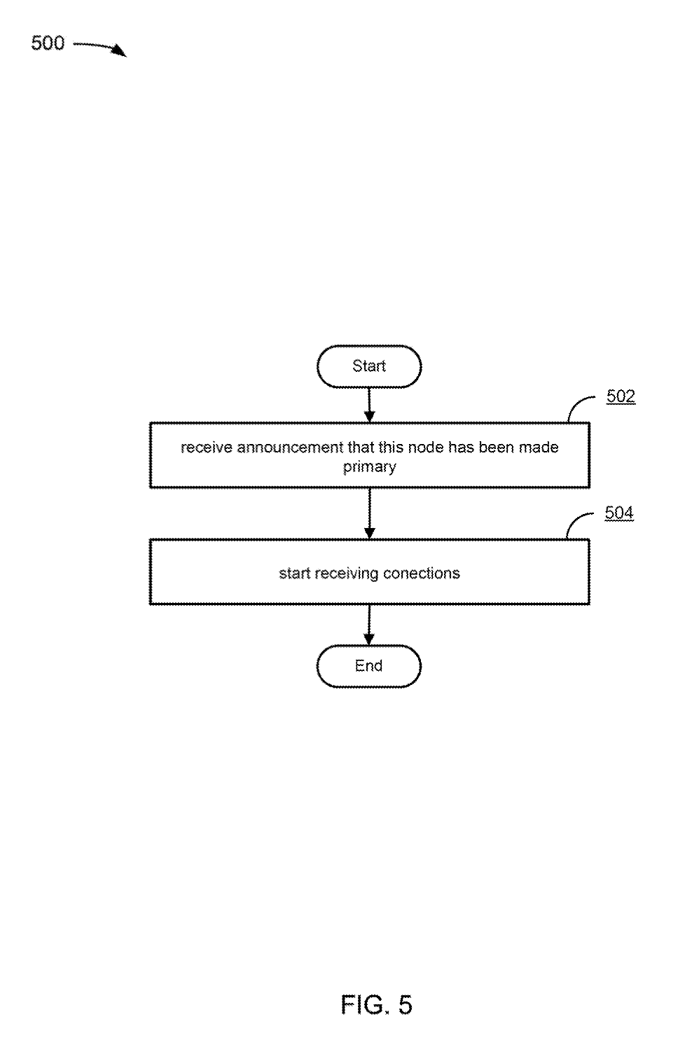

FIG. 4 depicts an example of an information service node 400. FIG. 4 includes network gear 404, compute gear 406, supervisor 408 and storage gear 410. FIG. 5 depicts a flowchart of an example of a method of distributing information.

In the example of FIG. 4, network gear 404 can include one or more network hardware units and associated connective cabling. Such could include a Juniper border router, F5 Firewall/virtual private network (VPN) unit, as well as various switches, cabling and other known convenient network components used to communicatively couple computing devices. Network gear 404 can be configured to provide intrusion detection and prevention functionality and comprises system(s), router(s), load balancer(s) and supporting data transport equipment, such as packet splitters, switching gear, repeaters, microwave equipment, laser and optical point to point gear, satellite systems, packet radio systems, etc.

In the example of FIG. 4, compute gear 406 can be a processing system. In one example, compute gear 406 is implemented with one or more electronic data processor/memory unit(s), typically physical computers, but in other examples, it can also include other types of e.d.p. such as a nested virtual machine, embedded system, or meshed mobile computing device. The processing system can be simple, complicated or of intermediate complexity. This can be as simple as a single processing unit or as complicated as having multiple hosts operating to provide many different computing systems together. For example, a multiple host system may include a virtualized system operating to provide many computing systems. Such a virtualized system can be operated using any known or convenient technology, including an ESX Hypervisor virtual machine management system.

In the example of FIG. 4, supervisor 408 can be a centralized computing system operable to control the activity of one or more computing systems such as network gear 404, compute gear 406, and storage gear 410. Supervisor 408 can provide decision management functionality to aggregate data and makes decisions to optimize an information service node as well as a system for distributing information. In one example, Supervisor 408 can be implemented with subsystem comprising a geo-cache system, distance metric cache system, and network balance cache system, service metering system, service monitoring system, and a system executive controller. Such a system can be operable to assign workloads, balance workloads and otherwise manage the operations of the associated computing systems.

In the example of FIG. 4, storage gear 410 can be a data storage system. The storage gear 410 comprises one or more information storage unit(s). A data storage system can be simple, complicated, or of an intermediate complexity. For example, a single drive may serve this function whereas another system may require the complexity of a storage area network (SAN) including multiple computing systems coupled by network fabric and involving many drives. Further, information storage units can be one or more of network attached storage, solid state storage, cloud storage, or other types of information storage systems.

In the example of FIG. 4, information service node 400 may include a geocache system. A geocache system can provide storage, retrieval and determination of geographic position(s). A geocache system may include geographic IP databases, a global positioning system (GPS), wireless network access information including, for example a WiFi SSID database or cell tower triangulation information.

In the example of FIG. 4, information service node 400 may include a distance metric cache system which provides storage, retrieval and determination of latency, hops, and quality of network service information, for example, such information could include a number of dropped or retransmitted packets, packets out of sequence or malformed, embedded quality of service (QoS) data, etc. The aggregate of these data inputs can be mathematically combined into a “distance” score. Such a score can be computed between computing components within a node, between nodes, between services, between services and service consumers, or any other two data end-points. In accordance with one example, a linear system is used with unreachable endpoints having a score of infinity and identical endpoints having a score of 0. In other examples, other scoring systems are used, including systems that use vectors to encode multi-variate scores like {h,q,l} where h is hops, q is QoS, and l is latency.

In the example of FIG. 4, information service node 400 may include a network balance cache system which provides storage, retrieval and determination of the degree to which a service is utilizing internal resources over the network as opposed to external resources. Services using large numbers of internal resources within an organization inside the node can be more efficient when located on the same physical strata. One example is a web server service making thousands of requests per second to a memory cache appliance service in the same organization. Services using minimal internal resources within an organization inside a node may benefit by operating closer to the geographical position of the service consumer. One example is a virtual desktop accessing only files within that virtual desktop's machine image.

In the example of FIG. 4, information service node 400 may include a service metering system. A service metering system can be enabled to measure the usage of resources such as compute, network, and storage. Such measurements are configured for billing purposes, but in addition, they also are enabled to effectuate service optimization. For example, a computationally intensive service can be switched to a node in a region with very low energy costs. In another, a data transfer intensive service is transferred to a node in a region with low bandwidth costs. It will be appreciated that each node is configurable with different cost metrics associated with variations of the commodity being metered.

In the example of FIG. 4, information service node 400 may include a service monitoring system. A service monitoring system can function to monitor the health of individual services, as well as the system and network in general. This can be a multi-variant measure of system health and includes both physical as well as virtual components.

In the example of FIG. 4, information service node 400 may include a system executive controller. Such a system executive controller can provide an adaptive heuristic-driven control functions that may include a rule-set, adaptive logic, and access to the various subsystems of a supervisor gear. A system executive controller can be configured to make decisions and change the configuration of a component or components of the interconnected network of nodes 200 directly, or by means of communication to other system executive subsystems in other nodes. These decisions can be driven (1) by the current state of the system in one embodiment, (2) by a predictive model of future state in another embodiment, or (3) by a combination of both current state of the system and predictive model of future in yet another embodiment. Examples of the current state include the operational state of a particular piece of hardware, a service consumer request, or the time of day among others. Examples of the predictive model of future state include utilization of Bayesian probability, neural network, or other means readily known to those skilled in the art.

In the example of FIG. 4, information service node 400 may include an intrusion detection and prevention system. Such a system can provide detection of and prevention of various threats to a node and its services, and are implemented by hardware and/or software security system(s). In one mode of operation, the intrusion detection and prevention system is operated in a redundant manner.

In the example of FIG. 4, information service node 400 may include a load balancer system. A load balancer system can route requests to appropriate services and maintain an appropriate utilization level among divergent components. Such a system can be configured to be operated in a redundant manner.

In the example of FIG. 4, information service node 400 may include a router system. The router system can network packets and distribute them to the appropriate system(s). The router system can be operated in a redundant manner.

In the example of FIG. 4, information service node 400 may include a service module. A service module can comprise electronic data processing methodology and sequences, such as those embodied in a software application, or virtualized information system. Examples can include: a web service, a database server, block storage, a virtualized desktop, a virtualized load balancer or network router, a collection of virtualized computers inter-networked with one or more service access points, and so forth.

In the example of FIG. 4, information service node 400 may include a Service Consumer module. The service consumer module can include functions to obtain data regarding the user of a service such as a human-being, device, or other service or client.

In the example of FIG. 4, information service node 400 may include a consumer location module. The consumer location module can include functions to obtain data for the geographical location of the user taking into account their means of access to the service.

In the example of FIG. 4, information service node 400 may include an organization module. The organization module can include functions to obtain data associated with the collection of services and authorized service consumers.

In the example of FIG. 4, information service node 400 may include an organization location(s) module. Such a module can include functions to obtain data about the principle information service node(s) of an organization.

In the example of FIG. 4, information service node 400 may include a private network link. A private network link can be configured to enable private or proprietary data communications over metropolitan fiber, metropolitan Ethernet, point to point microwave, point to point laser, or other such private communications systems, by way of examples.

In the example of FIG. 4, information service node 400 may include a virtual network link. A virtual network link can be a private data communications link within a virtualized system between one or more virtual machines. In some examples, this may be accomplished from a virtual machine to a physical network or between virtual load balances or other virtualized network gear.

At times the information service node 400 may need to request to connect to a service crosses a public, private or virtual network link. The requested service may be identified by any identification mechanism recognized by the network gear and requested service. For example, a service request might be identified by:

vnc://service_name.organization_name.lokahi.net:5900/

or by:

{host: 192.168.1.20, port:443, user: wendy, password: nene2012}.

In the example of FIG. 4, information service node 400 supervisor 408 is communicatively and closely coupled to network gear 404. Supervisor 408 may be capable of programming the network gear 404 to refuse and/or redirect a service request. This programming may occur even before a specific request is received based on the prior configuration of the organization, service, service consumer, and/or the adaptive rule set maintained by the supervisor 408. Additionally, supervisor 408 can be configured to similarly interact with virtualized networking gear residing within information service node 400.

FIG. 5 depicts a flowchart 500 of an example of a method for distributing information. The method is organized as a sequence of modules in the flowchart 500. However, it should be understood that these and other modules associated with other methods described herein may be reordered for parallel execution or into different sequences of modules.

In the example of FIG. 5, the flowchart starts at module 502 with receive announcement that this node had been made primary. The node can be a secondary node that is promoted to being a primary node in regard to the workload or alternatively can be a node that has no prior association with the workload. Once primary, the node receiving the announcement becomes associated with a particular workload and prepares to perform work associated with the workload. Such preparation may include the execution of programs on the node, the receipt of data to the node for processing or any other known or convenient steps for preparation.

In the example of FIG. 5, the flowchart continues to module 504 with start receiving connections. Once the node has become primary it can start receiving connections from customers. Such connections can include data requests, processing requests, or other known or convenient requests. As the node receives connections it undertakes to perform the workload. Having started receiving connections, the flowchart terminates.

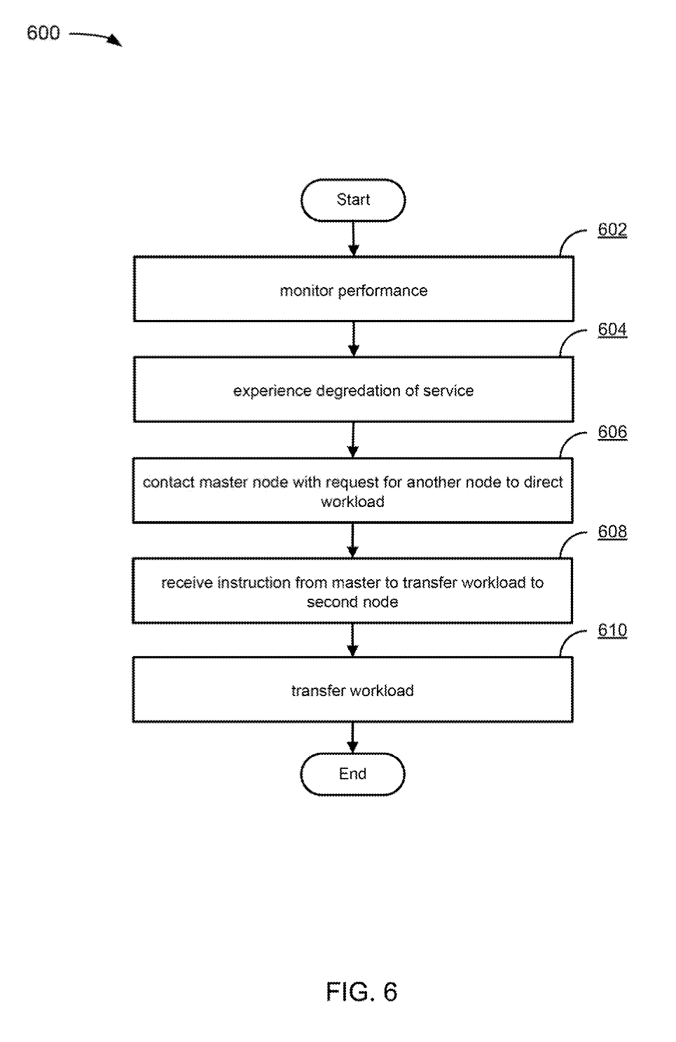

FIG. 6 depicts a flowchart 600 of an example of a method for distributing information. The method is organized as a sequence of modules in the flowchart 600. However, it should be understood that these and other modules associated with other methods described herein may be reordered for parallel execution or into different sequences of modules.

In the example of FIG. 6, the flowchart starts at module 602 with monitor performance. In monitoring performance of a node, various performance metrics can be gathered and analyzed to determine whether a node is providing a high level of service to customers. Key items include quick responses and moderate use of resources. A node operating outside these parameters may fail to perform its workload or otherwise service customers poorly.

In the example of FIG. 6, the flowchart continues to module 604 with experience degradation of service. The degradation of service may range from simple reduction in quality through the complete failure of a node to handle its workload. A node may be overloaded, may be experiencing a failure state, or may be performing at a lower level than is available on a different node.

In the example of FIG. 6, the flowchart continues to module 606 with contact master node with request for another node to direct workload. Any node identifying a low quality of service may report the degradation of service. This includes the ability of the master node to self report, or to initiate a report on another node.

In the example of FIG. 6, the flowchart continues to module 608 with receive instruction from master to transfer workload to second node. A master node may be configured to move individual services, groups of related services within an organization, or entire organizations between nodes based on rule sets. These rule sets can be hardcoded into nodes, made adaptive, or otherwise be provided in the nodes. Rule sets can be configurable so that they can be overridden manually in batch or real time modes of operation. Also, a supervisor can operate to provide instructions from a master node.

In the example of FIG. 6, the flowchart continues to module 610 with transfer workload. Moving a workload can involves a sequence of actions specific to the service and can take into consideration the dependencies of the service. For example, if a workload requires the use of a web server service which relies on a database service, those two services can be moved together in such a manner that the dependencies would remain intact. For example, if two services are moved in tandem, one service can be moved while simultaneously programming a virtual or physical network gear to redirect requests to/from the other. In another simpler example, a workload requiring only data storage can be moved by transferring the data itself. Having transferred workload, the flowchart terminates.

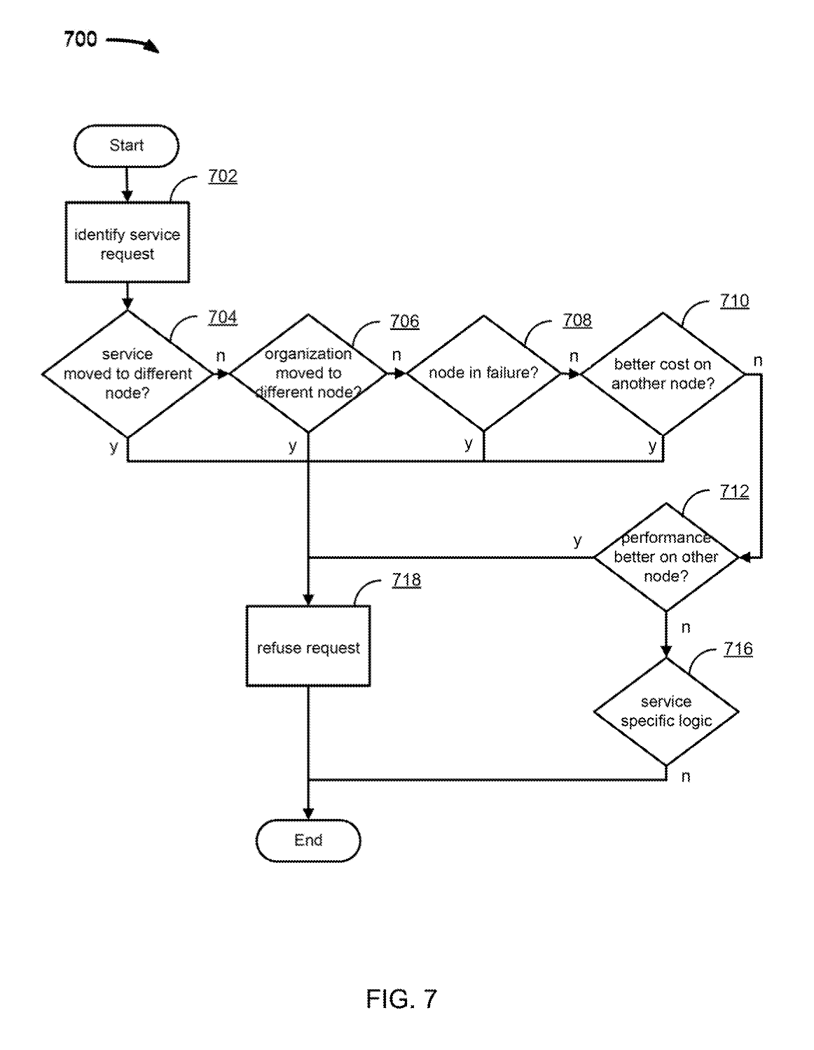

FIG. 7 depicts a flowchart of an example of a method of distributing information. The method is organized as a sequence of modules in the flowchart 700. However, it should be understood that these and other modules associated with other methods described herein may be reordered for parallel execution or into different sequences of modules.

In the example of FIG. 7, the flowchart starts at module 702 with identify service request. A service request can be a part of the workload handled by a node. This service request, or the entire workload itself can be transferred to another node for one or more reasons. By way of example, such reasons can include (A) determining that a node is in a failure state, (B) determining that operational cost of the service(s) or organizations(s) would be lower on a different node, (C) determining that the operational performance of the service(s) or organization(s) would be higher on a different node, and (D) receiving a request from the service or service customer that that the service be moved to a different node.

In the example of FIG. 7, the flowchart continues to decision module 704 with determining whether the service was moved to different node. This determination can be no where the service remains resident on the node and is otherwise ready to be moved. However, the decision can be no if the service has already been moved to another node. If the decision at 704 is no then the flowchart proceeds to decision module 706. If the decision at 704 is yes then the flowchart proceeds to module 718 with refusing the request because the service has already been moved and then terminates.

In the example of FIG. 7, the flowchart continues from decision module 704 to decision module 706 with determining whether the organization was moved to different node. This determination can be no where the organization associated with the service request and/or its workload have not otherwise been moved. The decision can be yes where the organization has already been moved to a different node and therefore cannot be moved. If the decision at 706 is no then the flowchart proceeds to decision module 708. If the decision at 706 is yes then the flowchart proceeds to module 718 with refusing the request and then terminates.

In the example of FIG. 7, the flowchart continues from decision module 706 to decision module 708 with determining whether the node is in failure. The decision can be no if the node that the service is going to be moved to is not in failure meaning that it can handle the incoming work. If the decision at 708 is no then the flowchart proceeds to decision module 710. Alternatively, the decision can be yes where the node used to receive the service is not in operation or otherwise in failure. If the decision at 708 is yes then the flowchart proceeds to module 718 with refusing the request and then terminates.

In the example of FIG. 7, the flowchart continues from decision module 708 to decision module 710 with determining whether there is a better cost on another node. If the decision at 710 is no then the flowchart proceeds to decision module 712. The decision can be no where a comparable node is available and offering better features, e.g. closer geographic proximity, and/or lower latency etc. The decision can be yes where there is not a better node available. If the decision at 710 is yes then the flowchart proceeds to module 718 with refusing the request and then terminates.

In the example of FIG. 7, the flowchart continues from decision module 710 to decision module 712 with determining whether performance is better on another node. The decision can be no where there are no nearby nodes with higher available resources for handling the workload. If the decision at 712 is no then the flowchart proceeds to module 716. The decision can be yes where there is a nearby node having higher available resources. If the decision at 712 is yes then the flowchart proceeds to module 718 with refusing the request and then terminates.

In the example of FIG. 7, the flowchart continues to module 716 with determining whether to apply any service specific logic. The decision can be yes in the event that moving the service requires any specific logic to be implemented then this is identified and implemented and the service is moved. However, the answer can be no if no specific logic is required. In such event the service can be moved without such additional logic. Having moved the service, the flowchart terminates.

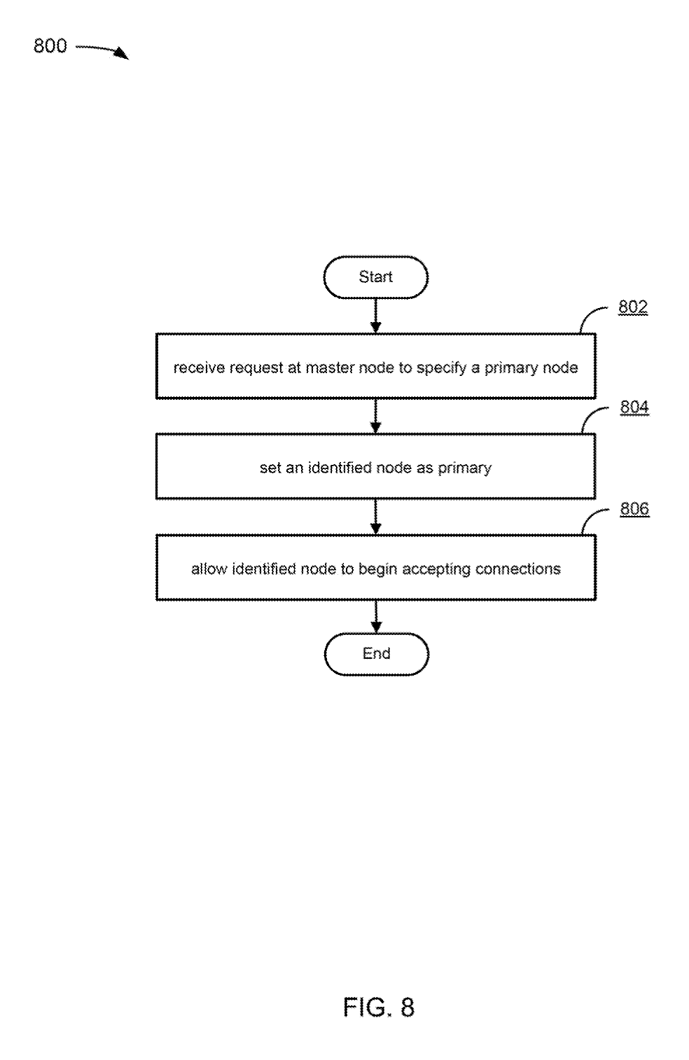

FIG. 8 depicts a flowchart 800 of an example of a method of responding to a request to specify a primary node. The method is organized as a sequence of modules in the flowchart 800. However, it should be understood that these and other modules associated with other methods described herein may be reordered for parallel execution or into different sequences of modules.

In the example of FIG. 8, the flowchart starts at module 802 with receiving a request at master node to specify a primary node. A workload can be associated with a particular node, the primary node for that workload. Such a primary node can service incoming requests from a customer or client. Where necessary, a primary node can distribute workload over to other nodes, whether by its own initiative or by instruction from a master node.

In the example of FIG. 8, the flowchart continues to module 804 with setting an identified node as primary. A node is designated as the primary node for a workload. Customers may be notified that the primary node is now the node to which it should provide all service requests.

In the example of FIG. 8, the flowchart continues to module 806 with allowing an identified node to begin accepting connections. As customers generate service requests, the service requests are transmitted to the primary node for handling. The identified node accepts these requests and begins servicing the workload. Having allowed identified node to begin accepting connections, the flowchart terminates.

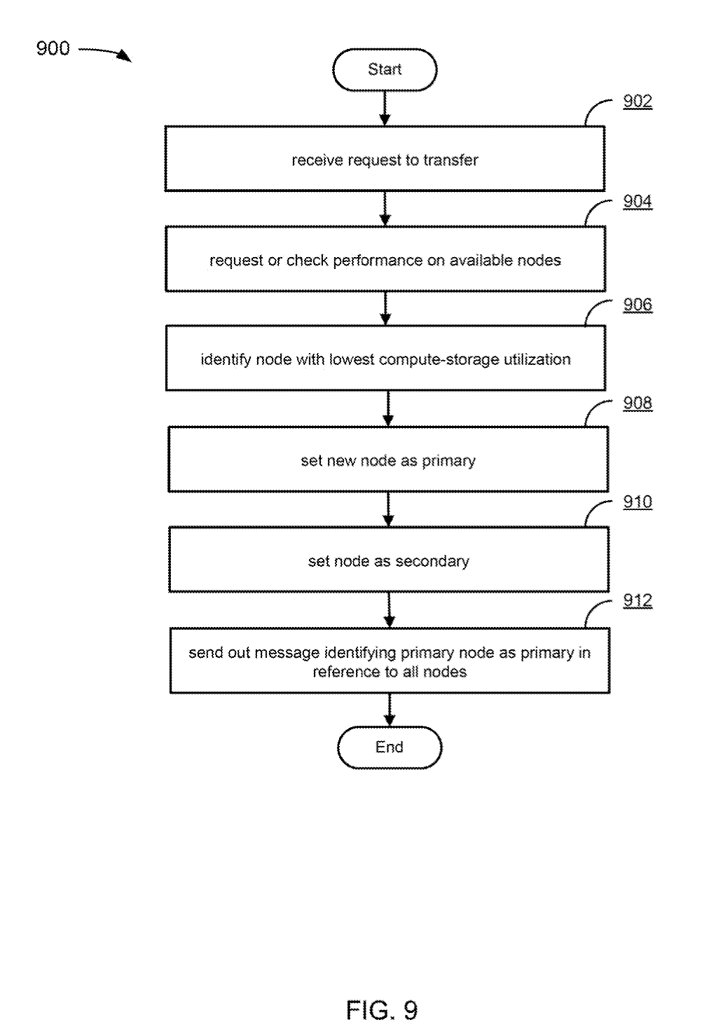

FIG. 9 depicts a flowchart 900 of an example of a method of distributing information. The method is organized as a sequence of modules in the flowchart 900. However, it should be understood that these and other modules associated with other methods described herein may be reordered for parallel execution or into different sequences of modules.

In the example of FIG. 9, the flowchart starts at module 902 with receiving a request to transfer. The request to transfer can seek to move workload from one node to another node, for example, where the primary node is overloaded or where there is high latency from the primary node to a customer associated with the workload.

In the example of FIG. 9, the flowchart continues to module 904 with requesting or checking performance on available nodes. Performance data can be regularly collected from the nodes and compiled into a database for reference. Performance data of the available nodes can be retrieved the database and analyzed to identify the available nodes. Key data points can include the memory utilization, processing capacity utilization and data storage utilization.

In the example of FIG. 9, the flowchart continues to module 906 with identifying the node with the lowest compute-storage utilization. The node with the lowest compute-storage utilization can be a node determined by any known or convenient formula. The purpose would be to identify available resources at the node so as to provide node that will be able to undertake the workload.

In the example of FIG. 9, the flowchart continues to module 908 with setting a new node as primary. The identified node can be set as a primary node for the workload. Customer requests can be directed to the primary node for handling of requests, processing, data storage and other associated workload.

In the example of FIG. 9, the flowchart continues to module 910 with setting the node as secondary. The node that was previously the primary node for the workload can be reduced to a secondary node. The secondary node can serve as a backup in the case that the primary node becomes overloaded or requires more than one node to handle the workload for a period of time.

In the example of FIG. 9, the flowchart continues to module 912 with sending out a message identifying the primary node as primary in reference to all nodes. Each node can identify the primary node for a particular customer. The message, or announcement can cause the other nodes to direct any service requests or related data to the primary node. Having sent out message identifying primary node as primary in reference to all nodes, the flowchart terminates.

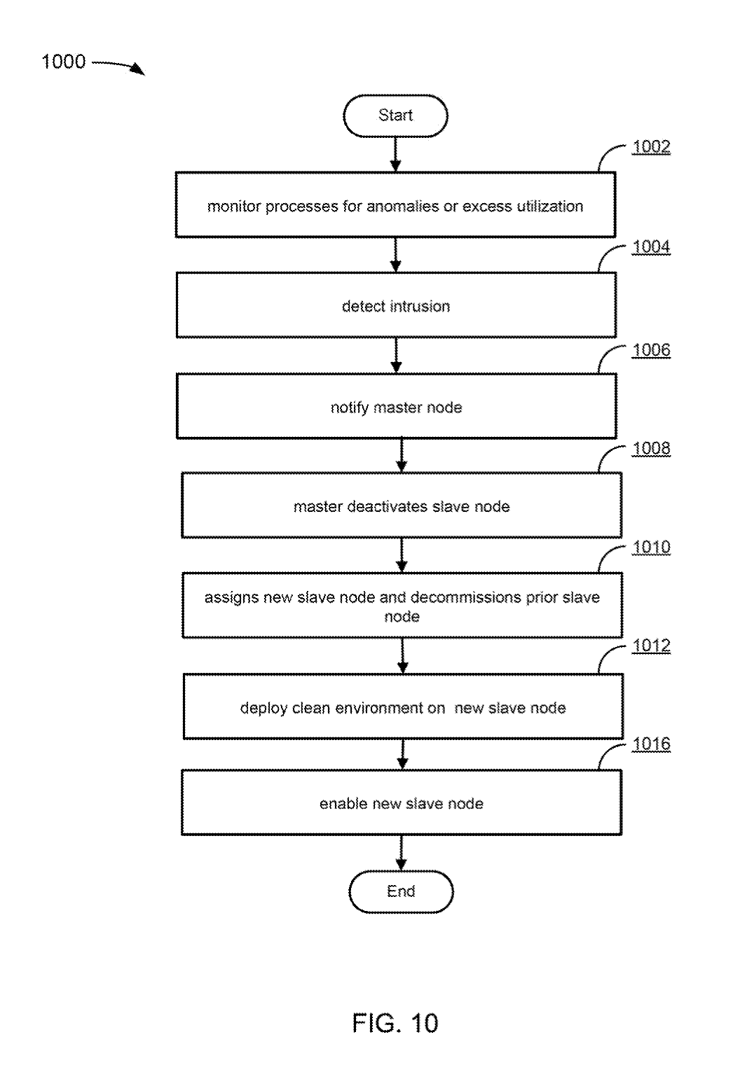

FIG. 10 depicts a flowchart 1000 of an example of a method of distributing information. The method is organized as a sequence of modules in the flowchart 1000. However, it should be understood that these and other modules associated with other methods described herein may be reordered for parallel execution or into different sequences of modules.

In the example of FIG. 10, the flowchart starts at module 1002 with monitoring processes for anomalies or excess utilization. Excess utilization can be indicative of an intrusion or malicious use. Anomalies can include various items including logins to inactive accounts, heavy traffic on uncommonly used ports, or any other known anomaly associated with the use of a computing system.

In the example of FIG. 10, the flowchart continues to module 1004 with detecting an intrusion. Whether sourced with an identified anomaly or directly identified from the intrusion itself, an intrusion can be a breach of security of a node. The node would appear to be compromised requiring immediate action.

In the example of FIG. 10, the flowchart continues to module 1006 with notifying master node. A message can be sent to the master node to inform the master node of the intrusion. The message may request action or can be merely an announcement of the problem.

In the example of FIG. 10, the flowchart continues to module 1008 with master deactivates slave node. In order to contain the intrusion, the compromised node can be disabled so as to prevent the intruder from accessing other nodes in the system for distributing information. Prior to deactivation a snapshot of the node can be taken and stored for reference and review of the anomaly. Such can be used to identify a source of the anomaly, make changes to nodes, or otherwise strengthen nodes. Once disabled, the node may or may not be able to communicate. The node can be required to terminate all active connections, power down, and/or take other steps to prevent further intrusion. At this point the node ceases accepting new connections associated with the workload.

In the example of FIG. 10, the flowchart continues to module 1010 with assigning a new slave node and decommissions prior slave node. One or more new slave nodes can be assigned to handle the workload handled by the compromised node. The prior slave node may have served as a primary node handling some workloads and may have been a secondary node for others. In decommissioning the prior slave node messages can be transmitted to all other indicating that the prior slave node no longer handles the workload.

In the example of FIG. 10, the flowchart continues to module 1012 with deploying a clean environment on the new slave node. The clean environment can be deployed by restoring a copy of the environment from a backup or other clean copy. In some cases the environment may be restored using a virtualized environment in which the clean copy is executed in the virtual system in place of the compromised environment.

In the example of FIG. 10, the flowchart continues to module 1016 with enabling the new slave node. The restored system can be enabled and used. The new slave node can begin receiving connections and servicing workload. If necessary the new slave node can be made a primary node as well. Having enabled the new slave node, the flowchart terminates.

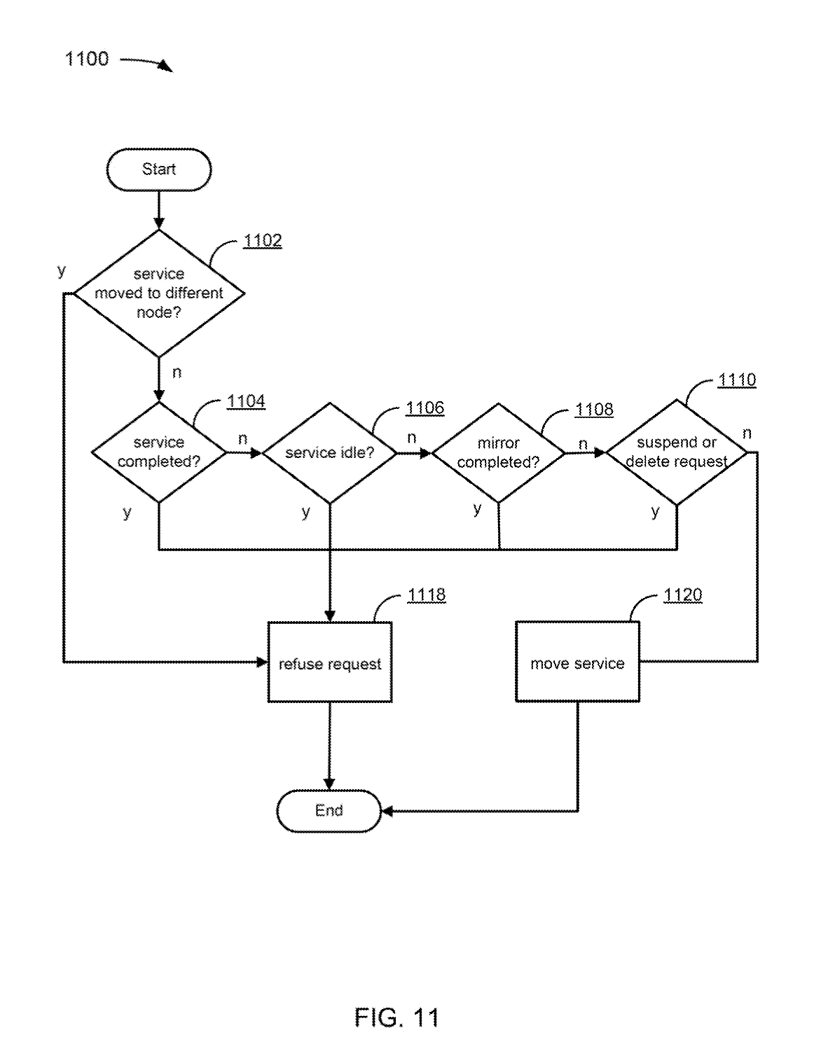

FIG. 11 depicts a flowchart of an example of a method for moving a service. The method is organized as a sequence of modules in the flowchart 1100. However, it should be understood that these and other modules associated with other methods described herein may be reordered for parallel execution or into different sequences of modules.

In the example of FIG. 11, the flowchart starts at decision module 1102 with determining whether the service was moved to a different node. The answer can be yes where the service was already moved and the answer can be no where the service is still operating on the current node. In the example of FIG. 11, if the answer at module 1102 is yes, then the flowchart continues to module 1118 with refusing the request and terminates.

In the example of FIG. 11, the flowchart continues from decision module 1102 to decision module 1104 with determining whether the service was completed. The decision can be yes where the node has finished the service and no further action is required. The decision can be no where the node has not finished the service and further work can be performed on transfer of the service to another node for completion. If the decision at 1104 is no then the flowchart proceeds to decision module 1106. If the decision at 1104 is yes then the flowchart proceeds to module 1118 with refusing the request and the flowchart terminates.

In the example of FIG. 11, the flowchart continues from decision module 1104 to decision module 1106 with determining whether the service is idle. The decision can be yes where the service operating but has no current tasks for the node to perform. However, the answer can be no if the service has current tasks for transfer to another node. If the decision at 1106 is no then the flowchart proceeds to decision module 1108. If the decision at 1106 is yes then the flowchart proceeds to module 1118 with refusing the request and the flowchart terminates.

In the example of FIG. 11, the flowchart continues from decision module 1106 to decision module 1108 with determining whether the mirror completed. A mirror image of a service can be reproduced on a node. In the event such a mirror image is already present on a node there is no need to reproduce the service as the mirror image can be enabled. Therefore, the decision can be yes where the mirror image is already in place. The decision can be no where there is no mirror image. If the decision at 1108 is no then the flowchart proceeds to decision module 1110. If the decision at 1108 is yes then the flowchart proceeds to module 1118.

In the example of FIG. 11, the flowchart continues from decision module 1108 to decision module 1110 with determining whether to suspend or delete request. The decision can be no if there is a reason not to perform further action on the service at this time. However, the decision can be yes if there is action currently required for this service. If the decision at 1110 is no then having decided not to suspend or delete the request, the flowchart terminates. If the decision at 1104 is yes then the flowchart proceeds to module 1120.

In the example of FIG. 1100, the flowchart continues from decision module 1110 to module 1120 with moving the service. The decision to move the service can be returned to another process for aiding in the transfer of service(s) from one node to another. Alternatively, the service can be moved at this time. Having moved the service, the flowchart terminates.

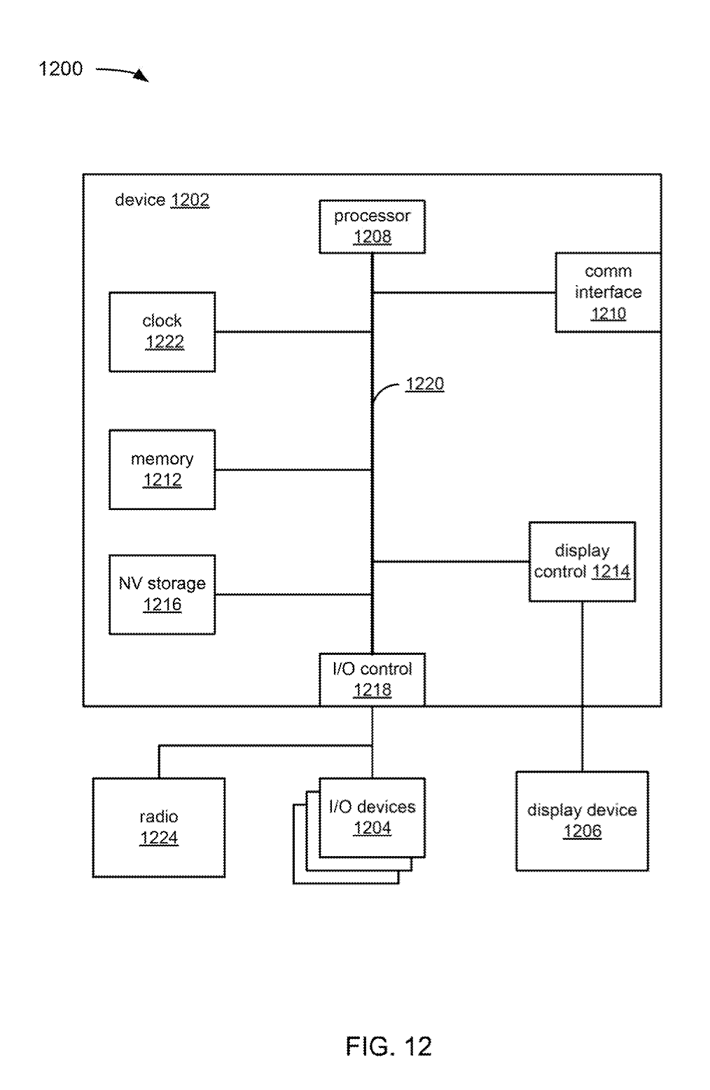

FIG. 12 depicts an example of a system 1200 for distributing information. The system 1200 may be a conventional computer system that can be used as a client computer system, such as a wireless client or a workstation, or a server computer system. The system 1200 includes a device 1202, I/O devices 1204, and a display device 1206. The device 1202 includes a processor 1208, a communications interface 1210, memory 1212, display controller 1214, non-volatile storage 1216, I/O controller 1218, clock 1222, and radio 1224. The device 1202 may be coupled to or include the I/O devices 1204 and the display device 1206.

The device 1202 interfaces to external systems through the communications interface 1210, which may include a modem or network interface. It will be appreciated that the communications interface 1210 can be considered to be part of the system 1200 or a part of the device 1202. The communications interface 1210 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 1208 may be, for example, a conventional microprocessor such as an Intel Pentium microprocessor or Motorola power PC microprocessor. The memory 1212 is coupled to the processor 1208 by a bus 1220. The memory 1212 can be Dynamic Random Access Memory (DRAM) and can also include Static RAM (SRAM). The bus 1220 couples the processor 1208 to the memory 1212, also to the non-volatile storage 1216, to the display controller 1214, and to the I/O controller 1218.

The I/O devices 1204 can include a keyboard, disk drives, printers, a scanner, and other input and output devices, including a mouse or other pointing device. The display controller 1214 may control in the conventional manner a display on the display device 1206, which can be, for example, a cathode ray tube (CRT) or liquid crystal display (LCD). The display controller 1214 and the I/O controller 1218 can be implemented with conventional well known technology.

The non-volatile storage 1216 is often a magnetic hard disk, flash memory, an optical disk, or another form of storage for large amounts of data. Some of this data is often written, by a direct memory access process, into memory 1212 during execution of software in the device 1202. One of skill in the art will immediately recognize that the terms “machine-readable medium” or “computer-readable medium” includes any type of storage device that is accessible by the processor 1208.

Clock 1222 can be any kind of oscillating circuit creating an electrical signal with a precise frequency. In a non-limiting example, clock 1222 could be a crystal oscillator using the mechanical resonance of vibrating crystal to generate the electrical signal.

The radio 1224 can include any combination of electronic components, for example, transistors, resistors and capacitors. The radio is operable to transmit and/or receive signals.

The system 1200 is one example of many possible computer systems which have different architectures. For example, personal computers based on an Intel microprocessor often have multiple buses, one of which can be an I/O bus for the peripherals and one that directly connects the processor 1208 and the memory 1212 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1212 for execution by the processor 1208. A Web TV system, which is known in the art, is also considered to be a computer system, but it may lack some of the features shown in FIG. 12, such as certain input or output devices. A typical computer system will usually include at least a processor, memory, and a bus coupling the memory to the processor.

In addition, the system 1200 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1216 and causes the processor 1208 to execute the various acts required by the operating system to input and output data and to store data in memory, including storing files on the non-volatile storage 1216.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A method of distributing information comprising:
in memory coupled to a processor, monitoring performance of a first node for a degradation of quality in servicing a workload for customers on the first node;
identifying the degradation on the first node;
contacting a master node with a request to transfer the workload from the first node to a second node to thereby increase the quality of operation provided to customers in servicing the workload; and
transferring workload to the second node in response to an instruction from the master node to transfer the workload.

2. The method of claim 1, further comprising setting the second node as a primary node for the workload.

3. The method of claim 1, further comprising causing the first node to cease accepting new connections associated with the workload.

4. The method of claim 1, wherein the second node is identified as having low latency relative to the customer associated with the workload.

5. The method of claim 1, wherein the second node is identified as having a high percentage of available compute resources.

6. A method of distributing information comprising:
in memory coupled to a processor, receiving a request to transfer a workload away from a first node to bring the workload in closer geographic proximity with a customer associated with the workload;
identifying the second node with closer geographic proximity to the customer, and
transferring the workload and related data storage to the second node.

7. The method of claim 6, wherein the geographic location of the customer is identified using customer geo-location data identifying the location of a customer device associated with the workload.

8. The method of claim 6, further comprising promoting the second node to a primary node for the customer workload.

9. The method of claim 6, further comprising announcing that the second node is a primary node for the customer workload.

10. A method of distributing information comprising:
in memory coupled to a processor, monitoring processes on a first node for anomalies that may compromise the node and reduce the quality of service of its operation in servicing a workload;
detecting an anomaly on the first node;
assigning a second node to service the workload operating on the first node thereby increasing the quality of operation provided to customers in servicing the workload;

11. The method of claim 10, further comprising creating a snapshot of the first node including evidence of the anomaly.

12. The method of claim 10, further comprising notifying a master node of the anomaly.

13. The method of claim 10, further comprising deactivating the first node.

14. The method of claim 10, wherein the anomaly is an intrusion into the first node in violation of security policy.

15. The method of claim 10, further comprising deploying a clean environment on the second node.
